(19) United States
(12) Patent Application Publication
(10) Pub. No.: US 2025/0313474 A1
(43) Pub. Date: Oct. 9, 2025

(54) SOLVENTS FOR CARBON NANOTUBE DISPERSIONS

(71) Applicant: ExxonMobil Technology and Engineering Company, Spring, TX (US)

(72) Inventors: Ozcan Altintas, Franklin Park, NJ (US); Thomas Sun, Clinton, NJ (US); Satish Bodige, Wayne, NJ (US); Bharath Natarajan, Basking Ridge, NJ (US); Adam B. Burns, Maplewood, NJ (US)

(73) Assignee: ExxonMobil Technology and Engineering Company, Spring, TX (US)

(21) Appl. No.: 18/881,633

(22) PCT Filed: Jul. 28, 2023
(86) PCT No.: PCT/US2023/028977

§ 371 Date: Jan. 6, 2025

Related U.S. Application Data
(60) Provisional application No. 63/370,801, filed on Aug. 9, 2022.

(51) Int. Cl. C01B 32/174

(52) U.S. Cl. CPC C01B 32/174; C01B 2202/28

(57) ABSTRACT

The present disclosure provides compositions and methods for dispersion of CNTs using a CNT solvent comprising an aromatic ring structure including at least one sulfonic acid functional group. Alternatively, the aromatic ring structure further includes at least a linear or branched alkyl chain. Examples of the carbon nanotube solvent includes dodecyl benzene sulfonic acid.

### CROSS REFERENCE TO RELATED APPLICATIONS

This Application is a National Stage Application, filed under 35 U.S.C. 371, of International Patent Application No. PCT/US2023/028977, filed Jul. 28, 2023, which claims the priority of U.S. Provisional Patent Application No. 63/370,801, filed Sep. 9, 2022, incorporated by reference in its entirety.

### FIELD

This disclosure relates to dispersion of carbon nanotubes (CNTs) and, more particularly, to dispersion of CNTs using a CNT solvent comprising an aromatic ring structure including at least one sulfonic acid functional group and optionally at least one alkyl chain.

### BACKGROUND

Carbon nanotubes (CNTs) are commonly mass produced as powders. But in the powder form, CNTs are not particularly useful due to their low aerial density and difficulty in further dry processing into stable structures. However, when dispersed into solvents, CNTs may be shaped by various means into desired forms for a range of applications. For instance, when stabilized in low concentration suspensions, CNT dispersions may be used as precursors to solution-cast nanocomposites, high surface area battery materials, conductive coatings for displays, membranes, and transistor arrays, among other uses. At higher concentrations, CNT suspensions may have additional uses, including, but not limited to, conductive inks for printed electronics or in liquid crystalline form, wet spun into fibers for composites or cables. In gel or paste form, CNTs may be formed by way of 3D printing/molding into CNT rich articles for structural applications.

A key hurdle to the widespread adoption of CNTs into various markets is the inability to reliably process them into desired forms from the solution state. This is due to the low stability of CNT in most common solvents owing to various factors such as their high aspect ratio, high molecular weight, and weakly interacting native surfaces. Further, due to their highly entangled and pre-aggregated dry forms, they are difficult to disperse into much smaller entities, bundles or even individual discrete nanotubes.

To this end, various methods have been developed to debundle or disentangle carbon nanotubes in solution. One method involves sonication of the carbon nanotubes in the presence of a surfactant, but the resultant dispersion usually contains surfactant or dispersal aid residues that are not removable, thus limiting commercial usage. Other methods involve the shortening of the carbon nanotubes prior to dispersing the individual nanotubes in dilute solution. Such dilute solution, however, typically contains a concentration of nanotubes that is generally not adequate for commercial usage.

Solvents for dispersing CNT's include superacids, such as chlorosulfuric acid, that disperse CNTs by surface protonation, thereby creating a net repulsion between the nanotubes. In addition to superacids, alkali metals have also been used to disperse CNTs. Both solvent families, however, have drawbacks that limit their commercial usage with CNTs. For example, both solvent families are very reactive to other chemicals (e.g., water), require highly specialized operating conditions, may leave a residue or chemically modify the CNTs, and are incompatible with other components when the processed material is combined in a product formulation, for example inkjet printing or composite fabrication.

### SUMMARY

Disclosed herein are methods comprising combining carbon nanotubes in a dry form with a carbon nanotube solvent, wherein the carbon nanotube solvent has an aromatic ring structure further including at least a sulfonic acid functional group; and mixing the carbon nanotubes and the carbon nanotube solvent to form a carbon nanotube suspension of the carbon nanotubes in the carbon nanotube solvent.

In one aspect, the present disclosure provides compositions comprising a carbon nanotube solvent having an aromatic ring structure further including at least a sulfonic acid functional group; and carbon nanotubes dispersed in the carbon nanotube solvent.

These and other features and attributes of the disclosed methods and systems of the present disclosure and their advantageous applications and/or uses will be apparent from the detailed description which follows.

### DETAILED DESCRIPTION

This application relates to methods and systems for dispersion of CNTs and, more particularly, to dispersion of CNTs using a CNT solvent comprising an aromatic ring structure further including at least one sulfonic acid functional group. The aromatic ring structure may further include an alkyl chain. In at least one embodiment, the aromatic ring structures are found in crude oil.

CNTs are cylindrical molecules made of carbon. As used herein, the term carbon nanotube or CNT includes single-walled CNTs and multi-walled CNTs. Single-walled CNTs are cylindrical molecules with a diameter of 3 nm or less formed from a single layer of carbon atoms. For example, single-walled CNTs are graphene sheets rolled into a cylindrical shape. Single-walled CNTs typically have a diameter close to 1 nm, for example, 3 nm or less, 2 nm or less, or 1 nm or less. Multi-walled CNTs include several concentrically interlinked tubes made of carbon. Multi-walled CNTs have a diameter of 50 nm or less, for example, of 1 nm to 15 nm or 1 nm to 10 nm. Whether single- or multi-walled, CNTs typically have a length much longer than their diameter and can have aspect ratios of 1000 or more. For example, CNTs can have an aspect ratio of 50 to 5,000, 100 to 5,000, 500 to 5,000, or 1,000 to 5,000. CNT lengths can reach several micrometers or even millimeters.

As described above, the development of liquid-state processing of CNTs has been particularly challenging due to difficulties in processing CNTs in liquid state. CNTs do not dissociate due to the strong carbon-carbon bonds (C—C) in the CNTs wall, and they are not soluble in organic or aqueous solvents. CNTs tend to form bundles rather than dissolving because of the strong van der Waals forces between their side walls as mentioned above. This is problematic because the nanotubes cannot be controlled and aligned in solution unless they are dispersed and distributed well in the suspension.

In accordance with present embodiments, CNTs in dry form are dispersed using a CNT solvent that has an aromatic ring structure. As used herein, references to dry CNT's are intended to include CNT's in powder form, pulp, and aerogel, but are not intended to include CNT's that are in slurry form or otherwise wetted. The aromatic ring structure of the CNT solvent includes at least one sulfonic acid functional group. Additionally, the aromatic ring structure of the CNT solvent can also include at least one alkyl chain, which can be linear or branched. Suitable ring structures are aromatic rings with 1-, or 2-, or 3-, or 4-, or 5-, or 6-, or 7-, or 8-, or more membered rings. In some embodiments, the rings are carbon rings, including benzene, toluene, ethyl benzene, xylene, cumene, mesitylene, durene, unsaturated cycloalkene, unsaturated cyclopentene, saturated cycloalkane, polycyclic aromatic such as naphthalene, partially hydrogenated derivative of naphthalene such as tetralin, anthracene or phenanthrene, pyrene, or any combination thereof. In some embodiments, the ring structure includes at least one heteroatom such as oxygen, nitrogen, or sulfur.

The aromatic ring includes a linear or branched alkyl chain. The alkyl chain can be substituted or unsubstituted. The alkyl chain can have any suitable chain length, including from 1 carbon to 50 carbons or from 6 carbons to 50 carbons. In some embodiments, the alkyl chain includes from 10 carbons to 50 carbons, from 10 carbons to 30 carbons, from 10 carbons to 20 carbons. In particular embodiments, the alkyl chain includes 12 carbons. As illustrated in the following examples, an aromatic ring structure of a single ring including a sulfonic acid group and an alkyl chain of 12 carbons (4-dodecylbenzene sulfonic acid) was shown to provide good dispersion of CNTs as compared to the same aromatic ring structure without sulfonation. Further, the alkyl chain can be in meta position to the sulfonic acid group or alternatively in ortho position to the sulfonic acid group or in para position to the sulfonic acid group.

Example embodiments include one-ring aromatics including at least one sulfonic acid functional group. Alternatively, other example embodiments include one-ring aromatics comprising at least one sulfonic acid functional group and at least one alkyl chain to give the following structures. The following structures are examples of one-ring aromatics including at least one sulfonic acid functional group and optionally at least one alkyl chain:

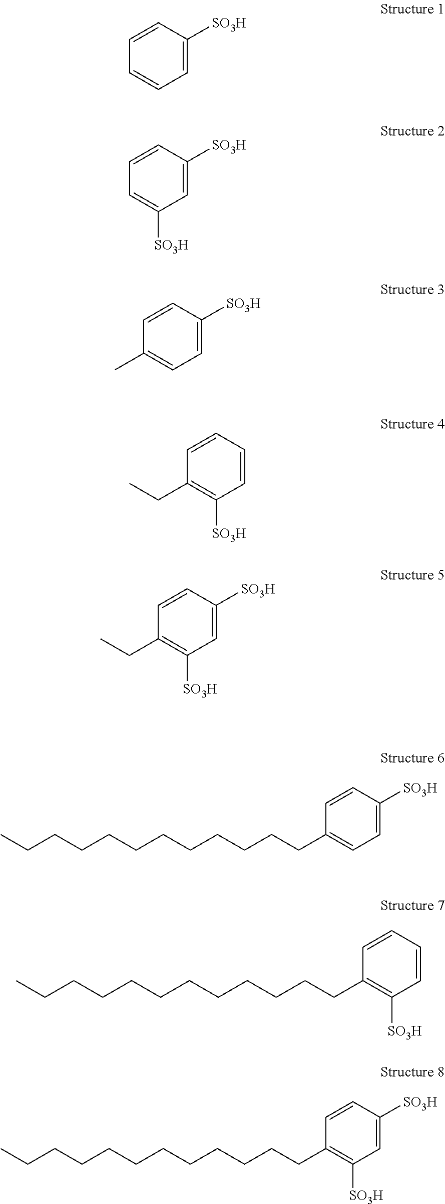

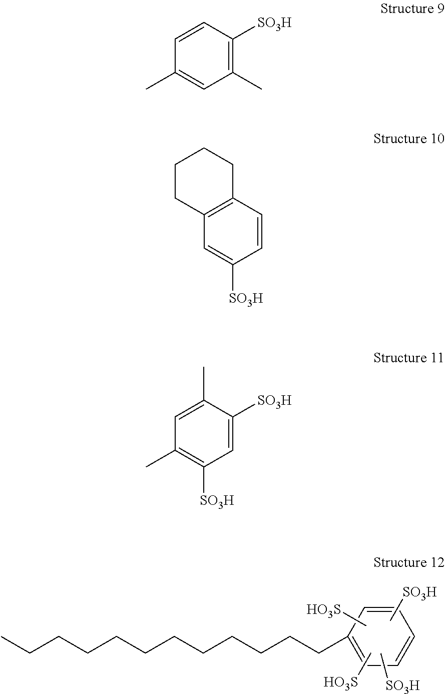

Example embodiments include two-ring aromatics comprising at least one sulfonic acid functional group. Alternatively, other example embodiments include two-ring aromatics comprising at least one sulfonic acid functional group and at least one alkyl chain to give the following structures. The following structures are examples of two-ring aromatics including at least one sulfonic acid functional group and optionally at least one alkyl chain:

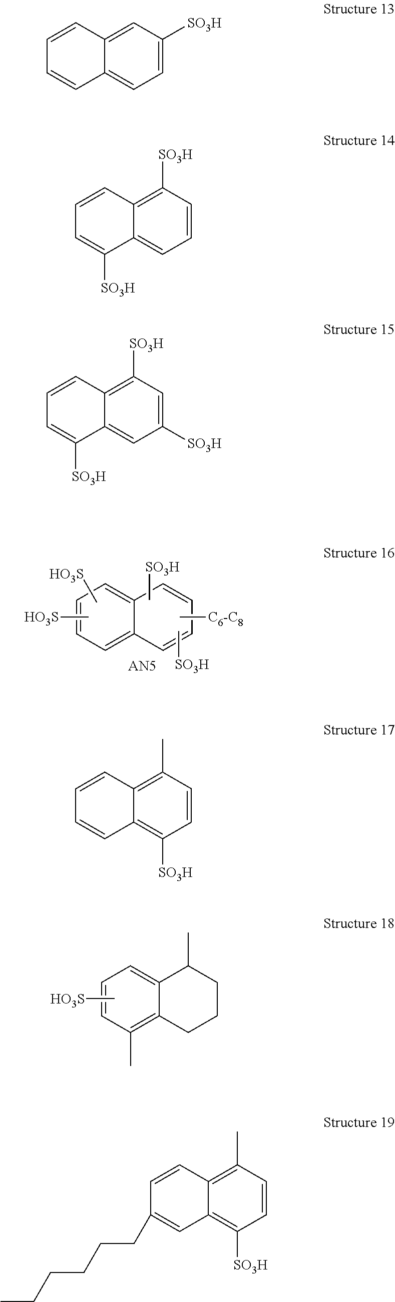

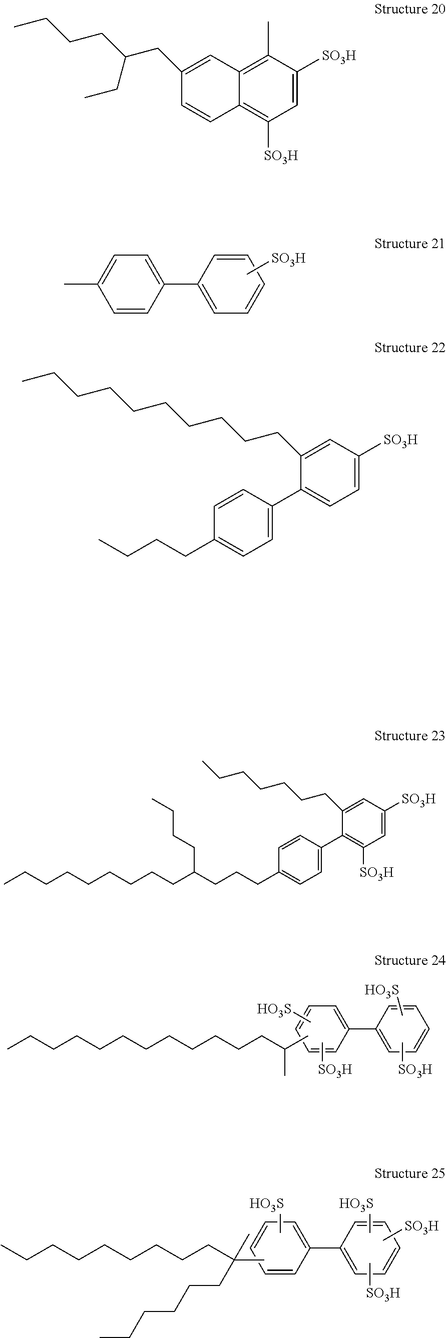

Example embodiments include three-ring aromatics comprising at least one sulfonic acid functional group and at least one alkyl chain to give the following structures:

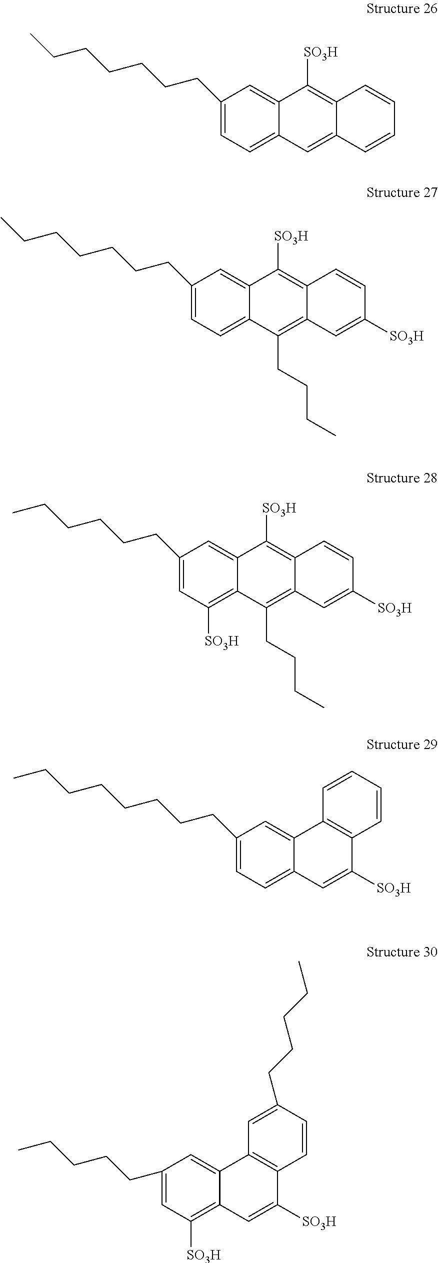 [SMILES: CCCCCCCc1ccc2cc3ccccc3c(S(=O)(=O)O)c2c1 ; CCCCCCCc1ccc2c(CCCC)c3cc(S(=O)(=O)O)ccc3c(S(=O)(=O)O)c2c1 ; CCCCCCc1cc(S(=O)(=O)O)c2c(CCCC)c3cc(S(=O)(=O)O)ccc3c(S(=O)(=O)O)c2c1 ; CCCCCCCCc1ccc2cc(S(=O)(=O)O)c3ccccc3c2c1 ; CCCCCc1ccc2c(S(=O)(=O)O)cc3c(S(=O)(=O)O)cc(CCCCC)cc3c2c1]

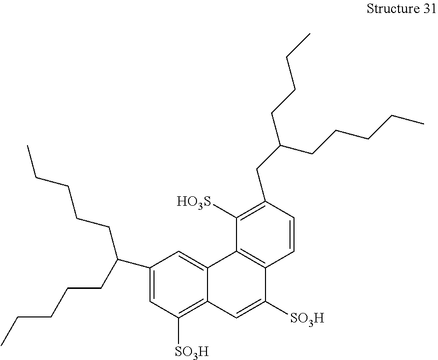 [SMILES: CCCCCC(CCCC)Cc1ccc2c(S(=O)(=O)O)cc3c(S(=O)(=O)O)cc(C(CCCCC)CCCCC)cc3c2c1S(=O)(=O)O]

In some embodiments, a CNT solvent includes mixture of aromatic ring structures that have been sulfonated, for example:

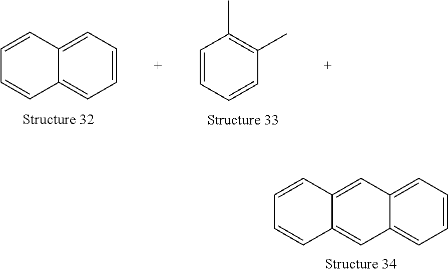

Any suitable technique may be used for the preparation of the CNT dispersant. For example, a ring structure can include at least one sulfonic acid group. Alternatively, a ring structure can include at least one sulfonic acid group and at least one alkyl chain of any length as selected in the cited building blocks. For example, a suitable aromatic ring structure is formed by sulfonation of an aromatic ring structure having an alkyl chain of 1 carbon to 50 carbons. As shown in the following reaction, example embodiments include sulfonation of dodecylbenzene to 4-dodecylbenzene sulfonic acid:

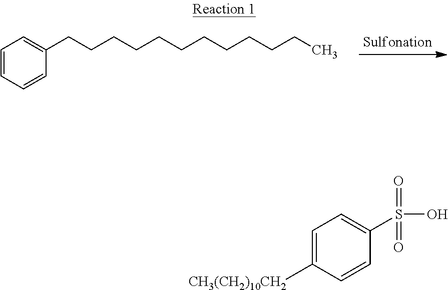

The aromatic ring structure used for the CNT solvent can be obtained from any suitable source. In one particular embodiment, the CNT aromatic ring is from crude oil. For example, suitable CNT solvents with the aromatic ring structure for forming the sulfonated aromatic ring structure may be obtained from various refinery process streams. In some embodiments, the aromatic ring structure from the refinery process stream includes the alkyl group. In some embodiments, the alkyl group is added to the aromatic ring structure from the refinery process stream. In some embodiments, refinery process streams containing aromatic hydrocarbon and aromatic heterocyclic compounds suitable for use in the disclosure herein may include or derive from, for example, steam cracker tar, main column bottoms, vacuum residue, heavy aromatic reformate (for instance C₉, C₁₀, C₁₁ or C₁₂), mogas, naphtha, C5 rock, C3-C5 rock, slurry oil, asphaltenes, bitumen, K-pot bottoms, lube extracts, and any combination thereof. These terms will be familiar to one having ordinary skill in the art. Particular discussion regarding these refinery process streams is provided hereinafter. Example embodiments, include sulfonating the aromatic ring structures obtained from these refinery process streams.

Steam cracker tar (also referred to as steam cracked tar or pyrolysis fuel oil) may comprise a suitable source of aromatic ring structures in some embodiments. “Steam cracker tar” is the high molecular weight material obtained following pyrolysis of a hydrocarbon feedstock into olefins. Suitable steam cracker tar may or may not have had asphaltenes removed therefrom. Steam cracker tar may be obtained from the first fractionator downstream from a steam cracker (pyrolysis furnace) as the bottom product of the fractionator, nominally having a boiling point of 288° C. and higher. In particular embodiments, steam cracker tar may be obtained from a pyrolysis furnace producing a vapor phase including ethylene, propylene, and butenes; a liquid phase separated as an overhead phase in a primary fractionation step comprising C5+ species including a naphtha fraction (e.g., C3-C10 species) and a steam cracked gas oil fraction (primarily C10-C15/C17 species having an initial boiling range of about 204° C. to 288° C.); and a bottoms fraction comprising steam cracker tar having a boiling point range above about 288° C. and comprising C15/C17+ species.

Main column bottoms (also referred to as FCC main column bottoms or slurry oil) may comprise a suitable source of aromatic ring structures in some embodiments. Typical aromatic ring structures that may be present in the main column bottoms include those having molecular weights ranging from about 250 to about 1000. One to eight fused aromatic rings may be present in some instances. Suitable main column bottoms may or may not have had asphaltenes removed therefrom. Residual cracking catalyst not removed cyclonically following cracking may or may not remain present in the main column bottoms. Both catalyst-containing and catalyst-free main column bottoms may be suitable for use in the present disclosure.

Vacuum residue may comprise a suitable source of aromatic ring structures. As the name suggests, “vacuum residue” is the residual material obtained from a distillation tower following vacuum distillation. Vacuum residue may have a nominal boiling point range of about 600° C. or higher.

C3 rock or C3-C5 rock may comprise a suitable source of aromatic ring structures. C3-C5 rock refers to asphaltenes that have been further treated with propane, butanes and pentanes in a deasphalting unit. Likewise, C3 rock refers to asphaltenes that have been further treated with propane. C3 and C3-C5 rock may be high in metals like Ni and V and may contain high amounts of N and S heteroatoms in heteroaromatic rings.

Bitumen or asphaltenes may comprise a suitable source of aromatic ring structures in some embodiments. Some sources consider bitumen and asphaltenes to be synonymous with one another. In general, asphaltenes refer to a solubility class of materials that precipitate or separate from an oil when in contact with paraffins (e.g., propane, butane, pentane, hexane, or heptane). Bitumen traditionally refers to a material obtained from oil sands and represents a full-range, higher-boiling material than raw petroleum.

Another suitable source of aromatic ring structures includes light aromatic streams including, for example, aromatics from catalytic reforming or steam cracking (e.g., BT(E)X and pyrolysis gasoline), reformate from catalytic reformers, or mixed linear or branched alkylated naphthalenes. Example embodiments, include sulfonating the aromatic ring structures obtained from these light aromatic streams.

Another suitable source of aromatic ring structures includes aromatic ring structures from a fluid catalytic cracking (FCC) heavy cut naphtha that has at least C₆₊ aromatics. Example embodiments include processing of a hydrocarbon feed including extracting aromatics from a fluid catalytic cracking (FCC) heavy cut naphtha that has at least C₆₊ aromatics, sulfonating the extracted aromatics containing an optional alkyl chain and mixing CNTs with the sulfonated C₆₊ aromatics. In some embodiments, the C₆₊ aromatics extraction is accomplished using a liquid-liquid extraction (LLE) system. Alternatively, the C₆₊ aromatics extraction unit is an extractive distillation (ED) system.

In one or more embodiments, the C₆₊ aromatics are extracted from the catalytic reforming unit, then the extracted C₆₊ aromatics containing an alkyl chain and/or at least one unsaturated cycloalkene and/or at least one saturated cycloalkane is sulfonated and the sulfonated C₆₊ aromatics containing an optional alkyl chain is mixed with CNTs.

In one or more embodiments, the C₆₊ aromatics are extracted from a heavy vacuum gas oil, then the extracted C₆₊ aromatics containing an alkyl chain and/or at least one unsaturated cycloalkene and/or at least one saturated cycloalkane is sulfonated and the sulfonated C₆₊ aromatics containing an optional alkyl chain is mixed with CNTs.

The CNTs solvent can be used to disperse CNTs in any suitable ratio. In some embodiments, the CNTs are included in the CNT solvent in an amount of 0.01 mg to 1 mg per ml of the CNT solvent. For example, the CNTs include in amount of 0.02 mg to 1 mg, 0.05 mg to 1 mg, 0.1 mg to 1 mg, 0.01 mg to 0.5 mg, or 0.1 mg to 0.5 mg per ml of the CNT solvent.

Any suitable technique may be used for the preparation of the CNT solvent. For example, a ring structure can include at least one sulfonic acid group and/or at least one alkyl chain of any length. CNTs in dry form are then combined with the CNT solvent and the mixture is then mixed. Any of a variety of suitable techniques can be used for mixing the CNTs and the CNT solvent, including mechanical agitation and sonication. In some embodiments, the CNTs are directly combined with the CNT solvent without the CNTs being combined with another solvent prior to the CNT solvent functionalized with at least one sulfonic acid group and at least one optional alkyl chain. As shown in the following example, direct combination CNTs in dry form with the CNT solvent provided a stable CNT dispersion as compared to use of a CNT solvent without sulfonation.

Accordingly, the present disclosure provides compositions and methods for dispersion of CNTs using a CNT solvent comprising an aromatic ring structure including at least one sulfonic acid functional group and at least one optional alkyl chain. The compositions and methods may include any of the various features disclosed herein, including one or more of the following statements.

Embodiment 1. A method comprising: combining dry carbon nanotubes with a carbon nanotube solvent, wherein the carbon nanotube solvent has an aromatic ring structure comprising at least a sulfonic acid functional group; and mixing the carbon nanotubes and the carbon nanotube solvent to form a carbon nanotube suspension of the carbon nanotubes in the carbon nanotube solvent.

Embodiment 2. The method of embodiment 1, wherein the aromatic of the carbon nanotube solvent comprises a one-ring or a two-ring aromatic.

Embodiment 3. The method of embodiment 1, wherein the aromatic of the carbon nanotube solvent comprises a three-ring aromatic.

Embodiment 4. The method of any of embodiments 1-3, wherein the aromatic ring structure further comprises at least one alkyl chain that is linear or branched.

Embodiment 5. The method of any of embodiments 1-4, wherein the alkyl chain of the carbon nanotube solvent comprises from 1 carbon to 10 carbons.

Embodiment 6. The method of any of embodiments 1-5, wherein the alkyl chain of the carbon nanotube solvent comprises from 10 carbons to 50 carbons.

Embodiment 7. The method of any of embodiments 1-6, wherein the carbon nanotube solvent comprises dodecyl benzene sulfonic acid.

Embodiment 8. The method of any of embodiments 1-7, wherein the carbon nanotube solvent comprises a mixture of structures 32-34 with sulfonation.

Embodiment 9. The method of any of embodiments 1-8, wherein the aromatic structure of the carbon nanotube solvent comprises at least one heteroatom.

Embodiment 10. The method of any of embodiments 1-9, wherein the aromatic structure of the carbon nanotube solvent is extracted from a refinery process stream.

Embodiment 11. The method of any of embodiments 1-10, wherein the aromatic structure of the carbon nanotube solvent is extracted from fluid catalytic cracking naphtha that comprises C₆₊ aromatics.

Embodiment 12. The method of any of embodiments 1-11, further comprising separating the aromatic structure from the fluid catalytic cracking naphtha using liquid-liquid extraction.

Embodiment 13. The method of any of embodiments 1-12, further comprising separating the aromatic structure from the fluid catalytic cracking naphtha using extractive distillation.

Embodiment 14. The method of any of embodiments 1-13, wherein the aromatic structure of the carbon nanotube solvent is extracted from a process stream from a catalytic reforming unit.

Embodiment 15. The method of any of embodiments 1-14, wherein the aromatic structure of the carbon nanotube solvent is extracted from a vacuum gas oil.

Embodiment 16. A composition comprising: a carbon nanotube solvent having an aromatic ring structure comprising at least a sulfonic acid functional group; and carbon nanotubes dispersed in the carbon nanotube solvent.

Embodiment 17. The composition of embodiment 16, wherein the aromatic ring structure further includes an alkyl chain.

Embodiment 18. The composition of any of embodiments 16-17, wherein the aromatic ring structure of the carbon nanotube solvent comprises benzene or xylene.

Embodiment 19. The composition of any of embodiments 16-18, wherein the aromatic ring structure of the carbon nanotube solvent comprises naphthalene or biphenyl.

Embodiment 20. The composition of any of embodiments 16-19, wherein the aromatic ring structure of the carbon nanotube solvent comprises at least one of anthracene or phenanthrene.

Embodiment 21. The composition of any of embodiments 16-20, wherein the aromatic ring structure of the carbon nanotube solvent comprises at least one heteroatom.

Embodiment 22. The composition of any of embodiments 16-21, wherein the carbon nanotube solvent comprises a dodecyl alkyl chain.

Embodiment 23. The composition of any of embodiments 16-22, wherein the carbon nanotube solvent comprises dodecyl benzene sulfonic acid.

Embodiment 24. The composition of any of embodiments 16-23, wherein the carbon nanotube solvent comprises a mixture of structures 32-34 with sulfonation.

Embodiment 25. The composition of any of embodiments 16-24, wherein the carbon nanotubes are disposed in the carbon nanotube solvent in an amount of about 0.01 mg to about 1 mg per ml of the carbon nanotube solvent.

### EXAMPLES

### Example 1

The following example was performed to illustrate the synthesis of a 4-dodecylbenzene sulfonic acid through sulfonation of 4-dodecylbenzene. For preparation of the sulfonated 4-dodecylbenzene, 44% silica sulfuric acid (5.62 g, 0.0229 mol, 1 equiv.) and dodecylbenzene (5 g, 0.0229 mol, mw: 218.12, 1 equiv.) in 1,2-dichloro-ethane (100 ml) were introduced into a 350 ml round bottomed flask. The reaction mixture was stirred at reflux temperature for 18 h. The heterogeneous mixture was then filtered and washed with dichloromethane (1×30 ml). The solvent was then removed under pressure and the product was then washed with hexane (2×20 ml) and dried under vacuum at ambient temperature. The dodecyl group may be in meta position (not shown) or in para position or in ortho position of the sulfuric acid group as displayed in Reaction 2 below:

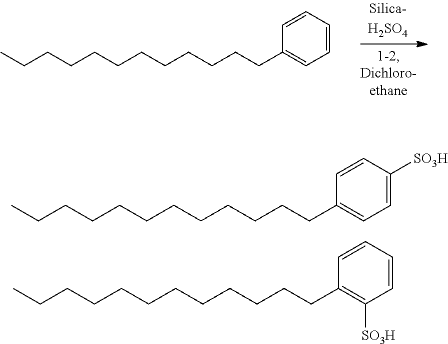

### Reaction 2

### Example 2

The following example was performed to illustrate sulfonation of a two-ring aromatic structure. For preparation of the sulfonated, two-ring aromatic structure, 44% silica sulfuric acid (11.24 g, 0.183 mol, 2 equiv.) and 1-methyl naphthalene (3.25 g, 0.0229 mol, mw: 142.20, 1 equiv.) in 1,2-dichloro ethane (100 ml) were introduced into a 350 ml round bottomed flask. The reaction mixture was stirred at reflux temperature for 18 h. The heterogeneous mixture was then filtered and washed with dichloromethane (1×30 ml). The solvent was removed under pressure and the product was washed with hexane (2×20 ml) and dried under vacuum at ambient temperature. The methyl group may be in meta position (not shown), or para position or in ortho position to the sulfuric acid group and two sulfonic acid group may also be bounded as shown in Reaction 3:

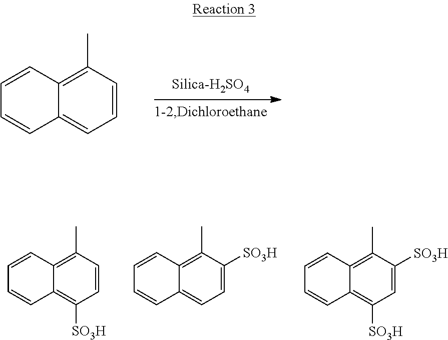

### Example 3

The following example was performed to illustrate how addition of a sulfonic acid group improved the performance of a CNT solvent. Dodecylbenzene contains an aromatic structure. However, it lacks a sulfonic acid functional group. Accordingly, 4-dodecylbenzene sulfonic acid was obtained and its performance as a CNT solvent was compared with dodecyl benzene. To test performance, CNT in dry form were directly added to dodecylbenzene in an amount of 0.0018 mg/ml or about 2 ppm. This mixture was sonicated for one hour with a 50% duty cycle and then allowed to sit in quiescent storage. After several hours, the CNT settled to the bottom of the dodecylbenzene. This test was repeated for the 4-dodecylbenzene sulfonic acid at a concentration of 1.1 mg/mL. In contrast to the dodecyl benzene, sulfonating dodecylbenzene into 4-dodecylbenzene sulfonic acid transforms it into a superior solvent for dispersing CNTs. The CNTs remained suspended in the 4-dodecylbenzene sulfonic acid with the mixture forming a thick paste that was stable for weeks.

While the disclosure has been described with respect to a number of embodiments and examples, those skilled in the art, having benefit of this disclosure, will appreciate that other embodiments can be devised which do not depart from the scope and spirit of the disclosure as disclosed herein. Although individual embodiments are discussed, the present disclosure covers all combinations of all those embodiments.

While compositions, methods, and processes are described herein in terms of “comprising,” “containing,” “having,” or “including” various components or steps, the compositions and methods can also “consist essentially of” or “consist of” the various components and steps. The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the disclosure, additionally, they do not exclude impurities and variances normally associated with the elements and materials used.

All numerical values within the detailed description are modified by “about” the indicated value, and take into account experimental error and variations that would be expected by a person having ordinary skill in the art.

Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated.

What is claimed is:

1. A method comprising:
combining dry carbon nanotubes with a carbon nanotube solvent, wherein the carbon nanotube solvent has an aromatic ring structure that comprises at least a sulfonic acid functional group; and
mixing the carbon nanotubes and the carbon nanotube solvent to form a carbon nanotube suspension of the carbon nanotubes in the carbon nanotube solvent.

2. The method of claim 1, wherein the aromatic of the carbon nanotube solvent comprises a one-ring aromatic.

3. The method of claim 1, wherein the aromatic of the carbon nanotube solvent comprises a two-ring aromatic.

4. The method of claim 1, wherein the aromatic of the carbon nanotube solvent comprises a three-ring aromatic.

5. The method of claim 1, wherein the aromatic ring structure further comprises at least one alkyl chain that is linear or branched.

6. The method of claim 5, wherein the alkyl chain of the carbon nanotube solvent comprises from 1 carbon to 10 carbons.

7. The method of claim 5, wherein the alkyl chain of the carbon nanotube solvent comprises from 10 carbons to 50 carbons.

8. The method of claim 1, wherein the carbon nanotube solvent comprises dodecyl benzene sulfonic acid.

9. The method of claim 1, wherein the carbon nanotube solvent comprises a mixture of the following base structures with sulfonation:

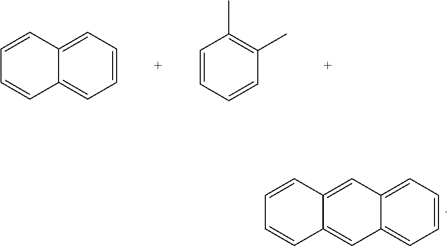

10. The method of claim 1, wherein the aromatic structure of the carbon nanotube solvent comprises at least one heteroatom.

11. The method of claim 1, wherein the aromatic structure of the carbon nanotube solvent is extracted from a refinery process stream.

12. The method of claim 11, wherein the aromatic structure of the carbon nanotube solvent is extracted from fluid catalytic cracking naphtha that comprises C₆₊ aromatics.

13. The method of claim 12 further comprising separating the aromatic structure from the fluid catalytic cracking naphtha using liquid-liquid extraction.

14. The method of claim 12, further comprising separating the aromatic structure from the fluid catalytic cracking naphtha using extractive distillation.

15. The method of claim 1, wherein the aromatic structure of the carbon nanotube solvent is extracted from a process stream from a catalytic reforming unit.

16. The method of claim 1, wherein the aromatic structure of the carbon nanotube solvent is extracted from a vacuum gas oil.

17. A composition comprising:
a carbon nanotube solvent having an aromatic ring structure comprising at least a sulfonic acid functional group; and
carbon nanotubes dispersed in the carbon nanotube solvent.

18. The composition of claim 17, wherein the aromatic ring structure further comprises an alkyl chain.

19. The composition of claim 17, wherein the aromatic ring structure of the carbon nanotube solvent comprises at least one of benzene or xylene.

20. The composition of claim 17, wherein the aromatic ring structure of the carbon nanotube solvent comprises at least one of naphthalene or biphenyl.

21. The composition of claim 17, wherein the aromatic ring structure of the carbon nanotube solvent comprises at least one of anthracene or phenanthrene.

22. The composition of claim 17, wherein the aromatic ring structure of the carbon nanotube solvent comprises at least one heteroatom.

23. The composition of claim 17, wherein the carbon nanotube solvent comprises a dodecyl alkyl chain.

24. The composition of claim 17, wherein the carbon nanotube solvent comprises dodecyl benzene sulfonic acid.

25. The composition of claim 17, wherein the carbon nanotube solvent comprises a mixture of the following structures with sulfonation:

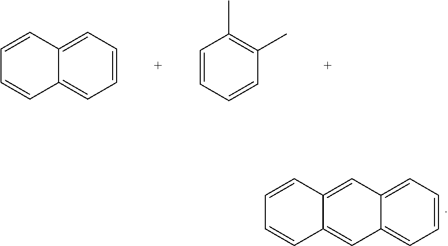

26. The composition of claim 17, wherein the carbon nanotubes are disposed in the carbon nanotube solvent in an amount of about 0.01 mg to about 1 mg per ml of the carbon nanotube solvent.
